(19) United States
(12) Patent Application Publication
(10) Pub. No.: US 2007/0192296 A1
(43) Pub. Date: Aug. 16, 2007

(54) MANAGING THE EXECUTION OF A QUERY

(76) Inventors: Louis Burger, Escondido, CA (US); Thomas Julien, San Diego, CA (US)

Correspondence Address: JAMES M. STOVER;NCR CORPORATION, 1700 SOUTH PATTERSON BLVD, WHQ4, DAYTON, OH, 45479, US

(21) Appl. No.: 11/557,521

(22) Filed: Nov. 8, 2006

Related U.S. Application Data
(60) Provisional application No. 60/735,474, filed on Nov. 10, 2005.

(51) Int. Cl. G06F 17/30

(52) U.S. Cl. 707/3

(57) ABSTRACT

A method and system for managing execution of a query that provides an avenue for runtime optimization, or more specifically runtime re-optimization. This allows for more efficient execution plans to be generated, and reduces the risk of major complications due to inadvertently poor estimates. In other cases such a query management system is used for alternate purposes, such as throttling system resource consumption for demanding queries.

### BACKGROUND

Typically, a relational database management system (RDBMS) includes a compile-time optimizer for optimizing a query, and a separate runtime subsystem for executing the query. The optimizer generates an execution plan, which represents a series of sequential steps that are carried out to execute the query. In theory, the execution plan represents a particularly efficient manner for execution. Known compile-time optimizers use a “look ahead” methodology to consider the effect of individual steps within the context of the query as a whole. This is advantageous given that the nature of one step typically has follow on effects on any subsequent steps.

Typically, compile time optimizers make a number of estimates when generating an execution plan. Where a query is executable as a plurality of steps having associated intermediate results, the optimizer estimates properties of these intermediate results. For example: the number of rows. Although known compile-time optimizers are quite sophisticated, it is not unknown for an estimate to be quite inaccurate. An inaccurate estimate usually has a follow through effect of reducing the efficiency of a subsequent step, which is often compounded further subsequent steps.

Runtime optimizers are also known. These optimizers obtain actual properties of an intermediate result prior to generating an execution plan for a subsequent step. This generally avoids the need for estimation and the associated difficulties. Despite this, known runtime optimizers are “greedy”. That is, they only look at the most efficient manner to perform the next step. In many cases, selecting the most efficient manner to perform a given step is inefficient in the context of subsequent steps or the query as a whole.

### SUMMARY

It is an object of the present invention to overcome or ameliorate at least one of the disadvantages of the prior art, or to provide a useful alternative.

In accordance with a first aspect of the invention, there is provided a system for managing execution of a query, the query being executable in a form including a step that provides an intermediate result for use by a subsequent step, the system including:
an interface for monitoring execution of the query to obtain data associated with the intermediate result; and
a processor responsive to the intermediate result for selectively allowing further execution of the query.

Preferably the processor is responsive to the intermediate result for selectively halting execution of the query. More preferably, the system includes a utility responsive to the processor for re-writing the query such that the step is replaced by a reference to the intermediate result. Even more preferably the utility re-writes the query in cases where the processor is intermediate result for selectively halting execution of the query.

Preferably the processor provides the re-written query to an optimizer for generating an execution plan for the re-written query. The re-written query is preferably released for execution in the database in accordance with the execution plan.

Preferably the interface obtains data indicative of an estimated property of the intermediate result. More preferably the data associated with the intermediate result includes data indicative of an actual execution property of the intermediate step. Preferably the processor is responsive to a threshold variation between the estimated property and the actual property for selectively either allowing further execution of the query or halting execution of the query. Data indicative of the intermediate result is preferably held in a spool file, and the execution property preferably relates to a property of the spool file.

In a preferred embodiment, the property of the spool file is maintained in a data dictionary. Preferably the data dictionary is a cache only dictionary.

In some embodiments the execution property is the quantum of rows in the spool file. In other embodiments the execution property is the physical file size of the spool file.

Preferably a compile-time optimizer generates an initial execution plan for the query prior to execution, and the interface obtains the data indicative of the estimated property of the intermediate result from the initial execution plan.

According to a second aspect of the invention, there is provided a method for managing execution of a query, the query being executable in a form including a step that provides an intermediate result for use by a subsequent step, the method including the steps of:
monitoring execution of the query to obtain data associated with the intermediate result; and
being responsive to the intermediate result for selectively allowing further execution of the query.

According to a further aspect of the invention, there is provided a method for re-optimizing a query at runtime including the steps of:
determining at runtime whether an existing execution plan for the query meets predefined criteria;
being responsive to the determination for selectively re-writing the query by reference to one or more known intermediate results; and
optimizing the re-written query.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:
FIG. 1 is a schematic representation of a system according to the invention; and
FIG. 2 is a flowchart showing an exemplary method relating to the system of FIG. 1.

### DETAILED DESCRIPTION

FIG. 1 illustrates a system 1 for managing execution of a query 2. Query 2 is executable in a compiled form including a step 3 that provides an intermediate result 4 for use by a subsequent step 5. System 1 includes an interface 6 for monitoring execution of query 2 to obtain data 7 associated with result 4. A processor 8 is responsive to result 4 for selectively allowing further execution of query 2.

Typically, a plurality of steps such as step 3 is executed to produce a respective plurality of results 4. As such, system 1 performs a cyclic task during execution of query 2; repeatedly obtaining data 7 associated with results 4 and repeatedly selectively allowing further execution of query 2.

Processor 8 is alternately responsive to result 4 for selectively providing a signal 9 indicative of a command to halt the execution of query 3. More specifically, in the described embodiments processor 8 is responsive to properties of result 4 for determining whether re-optimization of query 2 is justified. In cases where re-optimization is not justified, processor 8 takes no action, which allows further execution of query 2. Where re-optimization is justified, action is taken to effect this re-optimization, as described in detail below.

Although system 1 is used to selectively perform re-optimization of query 2, in other implementations similar systems are used to perform alternate query management functions. For example, in one embodiment execution of query 2 is permanently halted upon result 4 meeting certain criteria such that certain over-consumption of system resources is substantially prevented.

Query 2 is submitted for execution in a relational database 14. Execution relates to a process whereby a query result is obtained in response to a query. This query response is typically indicative of information obtained from database 14, or an error message. Execution completes when a query result is obtained. Where a query is halted, no query response is obtained, and as such execution is not completed. This is contrasted to a case where a query response in the form of an error message is defined upon receiving an invalid or unrecognizable intermediate result.

Following submission, a compile-time optimizer 15 optimizes the query in accordance with an inbuilt optimization protocol. More specifically, optimizer 15 performs searches and analysis to generate an execution plan for query 2. This execution plan is a plurality of typically sequential steps to be carried out under the control of a dispatcher 16 during execution. Appropriate optimizers will be known to those skilled in the art, and are generally included as part of a RDBMS. The specific protocols and operation of such optimizers is beyond the scope of the present disclosure.

In the present embodiment, which is based upon a typical RDBMS architecture, execution plans consist of a series of discrete execution steps where intermediate results are embodied in the form of temporary spool files. These spool files are passed from one step to the next. It will be appreciated that result 4 is embodied in a spool file. When generating an execution plan, optimizer 15 estimates one or more properties of these spool files. For example: the number of rows or the physical file size. It will be appreciated that optimizer 15 has accurate knowledge of individual row properties, and as such is able to infer the number of rows from physical file size or vice versa. Relevant individual row properties include row size and row length, and embodiments of the invention optionally make use of either or both of these. Whether the number of rows or the physical file size is considered for the sake of system 1 is a matter of choice. For the sake of example, the number of rows is considered in the present embodiment. In other embodiments alternate properties of these spool files are used.

The manner in which spool files are handled in a pre existing database 14 is somewhat modified for the purposes of system 1. This is not required in all situations. Specifically, for the purposes of system 1, spool files are externalized such that they are uniquely identifiable by an identifier. Additionally, their properties—such as either or both of file size and number of rows—are made accessible to system 1 in the form of statistics stored in a data dictionary 17. To reduce the overheads inherently associated with dictionary maintenance, identifiers and statistics of spool files are maintained in a special cache only dictionary that is private to a database session through which query 2 is submitted.

Interface 6 obtains data indicative of an estimated property of result 4 from optimizer 15. In the present embodiment this involves actively obtaining data indicative of a relevant execution plan, whilst in other embodiments the relevant data is actively provided to interface 6 by another component such as optimizer 15 or dispatcher 16. The specific estimated property in this example is the number of rows in the spool file that embodies result 4. For the sake of simplicity, this is also referred to as “the number of rows of result 4”.

Although described components are generally regarded as discrete, it will be appreciated that the functionalities of two or more components are often integrated into a single component. For example, in some embodiments some or all of the functionalities of system 1 are integrated into dispatcher 16.

Data 7 includes data indicative of an actual execution property of step 3, in the present embodiment being the number of rows of result 4. As such, interface 6 obtains both an estimated value and actual value for the number of rows of result 4. For simplicity, these are referred to as “the estimated value” and “the actual value”.

Processor 8 is responsive to a threshold variation between the estimated value and the actual value for selectively either allowing further execution of query 2 or halting execution query 2. In the former case, processor 8 takes no action. In the latter case, processor 8 provides signal 9 to dispatcher 16. Dispatcher 16 is responsive to signal 9 for halting execution. The runtime context is saved for future reference.

The level of threshold variation varies between embodiments, and is typically dependant on the necessitated accuracy of estimates. For example, a variation of greater than 10% is not acceptable in some cases, and such a variation results in signal 9 being provides to halt execution. Typically however, much larger thresholds are used. In the present embodiment a variation of an order of magnitude is considered. For example, where the estimated value is 10 rows, and the actual value is over 100 rows.

Processor 8 commences a re-optimization process substantially concurrently with providing signal 9. A re-writing utility 18 is responsive to the commencement of the re-optimization process for re-writing the query 2, which at that time is a partially executed query.

A partially executed query is a query that has commenced execution, but not all steps in the execution plan have been performed. At any point during execution, there are two defined query portions: an executed portion defined by those steps of the execution plan that have been performed, and a non-executed portion defined by those steps of the execution plan that have not yet been performed.

Utility 18 re-writes query 2 such that, for the executed portion of query 2, tables, names and expressions in the original query language are replaced by references to relevant spool files generated during execution of the executed portion. These references make use of identifiers provided to the spool files. Put very simply, a portion of query 2 that represented step 3 is replaced by a reference to result 4. That is, query 2 involved performing step 3 to obtain result 4, and using result 4 to perform step 5. The re-written query simply involves using result 4 to perform step 5. Of course, this is an over simplification, not accounting for parallel steps and so on. However, utilities for performing the basis underlying of utility 18 are known. For example: utilities that process complex View or Derived Table definitions. In those cases, a definition is first materialized for a main query, and the main query is then rewritten to reference a materialized spool file.

Utility 18 exports a re-written query 19. FIG. 1 shows this re-written query as being exported to optimizer 15 for re-optimization. This is for the sake of representation only. In practice, optimizer 15 is typically called by system 1 to optimize query 19. Following optimization, Query 19 is then executed under the control of dispatcher 16 and supervision of system 1.

Re-optimization using re-written query 19 is distinguished from known runtime optimization approaches. Known approaches are inherently greedy by virtue of only considering subsequent steps individually and in isolation. In the present case, optimization of re-written query 19 results in a complete execution plan for remaining query steps. This takes advantage of existing look-ahead functionalities of optimizer 15 at runtime to allow convenient rectification of a critical estimation inaccuracy made at compile-time. This rectification is made in the context of the remaining steps as a whole. Effectively, optimizer 15 is called to re-optimize an entire non-executed portion of a query on the basis of more accurate information derived from actual results.

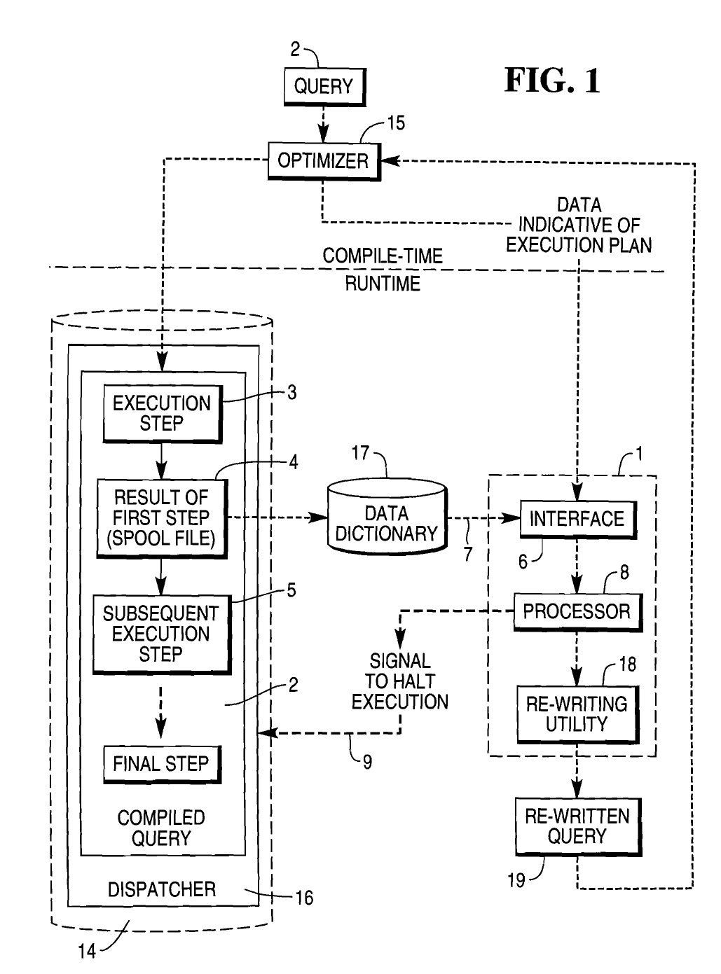

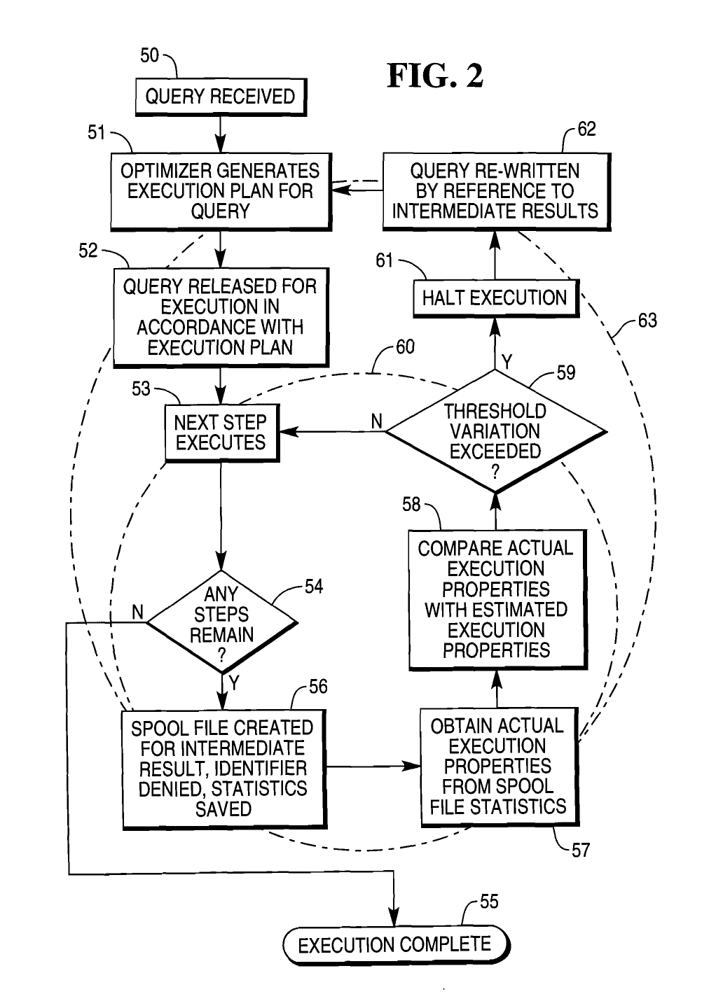

FIG. 2 provides a flowchart overview of an exemplary process for executing a query where system 1 is implemented. This flowchart is summarized below.

Query 2 is received at step 50. Optimizer 15 performs optimization and generates an execution plan at 51. At 52, query 2 is released for execution in database 14 in accordance with the generated execution plan.

At 53 the next sequential execution step executes under the control of dispatcher 16. A determination 54 is made in relation to whether any steps remain. Where no steps remain—that is, the step under execution is the final step, execution completes at 55. It will be recognized that a step receiving a positive answer to determination 54 is a step 3, and upon execution a result 4 is embodied in a spool file. This spool file is provided with an identifier, and statistics are saved in dictionary 17 at 56.

At 57 the actual number of rows in result 4 are obtained. This is compared with the estimated number of rows at 58 to allow a threshold variation determination at 59. Where the actual value differs from the estimated value by an order of magnitude or greater execution is halted at 60. Otherwise the next sequential step executes at 53 to define a primary loop 61. This primary loop repeats until either a threshold is breached or the final step is executed.

Where execution is hated at 60, utility 18 is called to re-write query 2 to define query 19 at 21. Query 19 is optimized at 51 to define a secondary loop 63. This secondary loop is a re-optimization loop, and is invoked in circumstances where optimizer 15 has made a sufficiently inaccurate estimate.

Where a query 2 has a large number of steps 2, it is possible for several passes to be made around each of loops 61 and 63. However, it will be appreciated that in a typical case—that being where optimizer 15 is sufficiently accurate in generating estimates—only loop 61 is used. Loop 63 is an exceptional loop used in a minority of cases. The additional time and processing power required to perform loop 63 is typically balanced by the reduced risk of complications due to a poor estimate, and follow on effects that may compound these complications. An example is provided below.

It will be recognized that each time optimizer 15 is re-invoked during execution, a full plan is generated that includes steps for the entire rewritten query. This is in contrast to a “greedy” approach that makes changes only to the next immediate step. Using this approach, impacts from the original inaccurate estimate are corrected in all remaining steps of the query plan. Essentially, the optimizer is allowed to go back and correct a critical mistake made at some point in its original search and then complete the remaining search process with the corrected information.

The following example demonstrates a case where the use of system 1 results in as improved execution plan. More specifically, knowing the actual size of an intermediate result allows the optimizer 15 to choose a more efficient join algorithm. The example is provided for the purposes of illustration only, and should not be regarded as limiting in any way.

Assume the following query description and associated SQL statement:

“Find all suppliers who are also customers and have made at least one order over $5,000.”
SELECT s_suppkey, s_name, s_phone
FROM supplier, customer, ordertbl
WHERE s_name=c_name AND s_phone=c_phone
AND c_custkey=o_custkey and o.total_price>5000

Also assume the following cardinalities:

‘supplier’ and ‘customer’ are medium sized tables (˜100,000 rows)

‘ordertbl’ is a large table (˜10,000,000 rows)

A large number of orders have a total_price>5000 (˜500,000)

Only a very small fraction of customers are also suppliers (˜100)

Given below is a likely query plan that would be chosen by a strict compile-time optimizer:

Step #A1—Retrieve ordertbl rows with total_price>5000 and store result in spool #1 which has an estimated number of result rows equal to 550,000

Step #A2—Join customer and supplier and store result in spool #2 which has an estimated number of result rows equal to 20,000

Step #A3—Sort both spools on their respective joining columns and join them using a merge-join algorithm

If statistics are available on column total_price, the compile-time optimizer will likely have an accurate estimate for the number of rows in spool #1. Estimating the cardinality of simple selection constraints can be done accurately using histograms or other standard distribution statistics. However, even with statistics on the relevant joining columns, the Optimizer typically is not able to make an accurate estimate for the number of rows in spool #2. Estimating join cardinality is often prone to serious errors because standard statistics (e.g., #unique values) do not capture the complex inter-relationship between tables. In this example, it is assumed that very few suppliers and customers share a common name and phone number and as a result the optimizer has significantly overestimated the size of spool #2 (20,000 estimated vs. 100 actual).

Because the size of spool #2 has been over-estimated, the Optimizer has chosen a safe conservative strategy, namely a merge-join, for joining the two spool files. In actuality, because the size of spool #2 is small, the choice of a hash-join algorithm would have delivered much better performance. Hash-join is a specialized join algorithm that works well when one of the two tables is small and its corresponding hash table can fit entirely in memory.

Using system 1, the optimizer first generates the plan shown above. Following step #A1 the actual and estimated number of rows are compared. The difference is tolerable—500,000 actual against 550,000 estimated—and progress continues around loop 61, and step #A2 is executed

Similarly, following step #A2 the actual and estimated number of rows are compared. The variation exceeds an order of magnitude threshold level—100 actual against 20,000 estimated. Definitions for spools #1 and #2 are added to dictionary 17, along with statistics that include their actual populated row counts. The original query is re-written to reference spools #1 and #2 as follows:
SELECT spool_2.s_suppkey, spool_2.s_name, spool_2.s_phone
FROM spool_1, spool_2
WHERE spool1_2.c_custkey=spool_1.o_custkey

The optimizer generates a new plan for this query. For the sake of example, the optimizer's chosen plan for this rewritten query is as follows:

Step #B1—Build hash table on spool #2 and perform hash join with spool #1

Step #B1 is then executed to complete execution of the original query.

By allowing the Optimizer to re-optimize the non-executed portion of the query at the point where the actual sizes of spools #1 and #2 are known, a better choice is made in relation to a strategy for joining the two spools. The improved execution plan is as follows:

Step #1—Retrieve ordertbl rows with total_price>5000 and store result in spool #1

Step #2—Join customer and supplier and store result in spool #2

Step #3 Build hash table on spool #2 and perform hash join with spool #1

Only a moderate number of enhancements are needed to a typical RDBMS architecture to support the above described optimization approach. Furthermore, the fundamental design of the an optimizer itself remains unchanged. Given below is a summary of enhancements to an exemplary existing RDBMS according to one implementation of system 1:

Execution Coordinator (“Dispatcher”). This component is responsible for executing steps in a compiled execution plan, and is extended to optionally call the optimizer after each step completes. Execution is temporarily halted and the runtime context saved. After the optimizer is called and a new plan generated, execution is resumed.

Query Rewriter. This component is responsible for applying query transformations prior to a cost based search phase of optimization. Among other things, it is responsible for rewriting queries that reference Views or Derived Tables. This component is extended to rewrite any partially executed query by replacing all executed portions of the query with the names of spool files that store corresponding intermediate results. Note that the rewritten SQL query does not need to be in the form of actual SQL text. Instead, it is more efficient to represent the rewritten query using an internal parse tree structure thereby avoiding the overhead of having to parse the SQL syntax each time.

Externalized Spool Files. Runtime spool files are externalized to the optimizer such that they can be uniquely identified by an identifier. In addition, their size (number of rows and bytes) is made accessible to the optimizer in the form of statistics stored in a data dictionary. To minimize the overhead normally associated with dictionary maintenance, the definitions and statistics for spool files can be kept in a special cache only dictionary that is private to a current session.

It will appreciated that the above disclosure provides a system for managing execution of a query that provides an advance for runtime optimization, or more specifically runtime re-optimization. This allows for more efficient execution plans to be generated, and reduced the risk of major complications due to inadvertently poor estimates. In other cases such a query management system is used for alternate purposes, such as throttling system resource consumption for demanding queries.

Although the present invention has been described with particular reference to certain preferred embodiments thereof, variations and modifications of the present invention can be effected within the spirit and scope of the following claims.

What is claimed is:

1. A system for managing execution of a query, the query being executable in a form including a step that provides an intermediate result for use by a subsequent step, the system including:
an interface for monitoring execution of the query to obtain data associated with the intermediate result; and
a processor responsive to the intermediate result for selectively allowing further execution of the query.

2. A system according to claim 1 wherein the processor is responsive to the intermediate result for selectively halting execution of the query.

3. A system according to claim 2 including a utility responsive to the processor for re-writing the query such that the step is replaced by a reference to the intermediate result.

4. A system according to claim 3 wherein the utility re-writes the query in cases where the processor is intermediate result for selectively halting execution of the query.

5. A system according to claim 4 wherein the processor provides the re-written query to an optimizer for generating an execution plan for the re-written query.

6. A system according to claim 6 wherein the re-written query is released for execution in the database in accordance with the execution plan.

7. A system according to claim 1 wherein the interface obtains data indicative of an estimated property of the intermediate result.

8. A system according to claim 7 wherein the data associated with the intermediate result includes data indicative of an actual execution property of the intermediate step.

9. A system according to claim 8 wherein the processor is responsive to a threshold variation between the estimated property and the actual property for selectively either allowing further execution of the query or halting execution of the query.

10. A system according to claim 9 wherein data indicative of the intermediate result is held in a spool file, and the execution property relates to a property of the spool file.

11. A system according to claim 10 wherein the property of the spool file is maintained in a data dictionary.

12. A system according to claim 11 wherein the data dictionary is a cache only dictionary.

13. A system according to claim 9 wherein the execution property is the quantum of rows in the spool file.

14. A system according to claim 9 wherein the execution property is the physical file size of the spool file.

15. A system according to claim 7 wherein a compile-time optimizer generates an initial execution plan for the query prior to execution, and the interface obtains the data indicative of the estimated property of the intermediate result from the initial execution plan.

16. A method for managing execution of a query, the query being executable in a form including a step that provides an intermediate result for use by a subsequent step, the method including the steps of:
monitoring execution of the query to obtain data associated with the intermediate result; and
being responsive to the intermediate result for selectively allowing further execution of the query.

17. A method for re-optimizing a query at runtime including the steps of:
determining at runtime whether an existing execution plan for the query meets predefined criteria;
being responsive to the determination for selectively re-writing the query by reference to one or more known intermediate results; and
optimizing the re-written query.
